(19) United States
(12) Patent Application Publication
(10) Pub. No.: US 2026/0192365 A1
(43) Pub. Date: Jul. 9, 2026

(54) ADDITIVE MANUFACTURING USING A REMOVABLE BUILD MODULE

(71) Applicant: FREEMELT AB, Mölndal (SE)

(72) Inventors: Ulf ACKELID, Göteborg (SE); Ulric LJUNGBLAD, Göteborg (SE); Martin WILDHEIM, Mölndal (SE); Robin STEPHANSEN, Mölndal (SE); Fredrik SELMOSSON, Kållered (SE)

(21) Appl. No.: 19/129,434

(22) PCT Filed: Nov. 8, 2023
(86) PCT No.: PCT/EP2023/081130

§ 371 Date: May 13, 2025

(30) Foreign Application Priority Data
Nov. 14, 2022 (SE) 2251338-6

(51) Int. Cl. B22F 12/00; B22F 10/32; B22F 12/20; B22F 12/41; B22F 12/50; B22F 12/80; B33Y 10/00; B33Y 30/00; B33Y 40/00

(52) U.S. Cl. CPC B22F 12/38; B22F 10/32; B22F 12/20; B22F 12/41; B22F 12/50; B22F 12/80; B33Y 10/00; B33Y 30/00; B33Y 40/00

(57) ABSTRACT

An apparatus for additive manufacturing includes a particle beam providing module and a removable build module. The removable build module includes: a build tank including walls; at least one powder supply tank; and a recoating arrangement arranged to recoat the build tank with powder from the at least one powder supply tank. The particle beam providing module and the removable build module together form a vacuum chamber when the removable build module is attached to the particle beam providing module in the apparatus, so that the walls of the build tank form a barrier part of the vacuum chamber.

### TECHNICAL FIELD

The present disclosure relates generally to additive manufacturing using a removable build module.

### BACKGROUND

In additive manufacturing using a particle beam, such as e.g. Electron Beam Powder Bed Fusion (E-PBF), vacuum is required in order for the particle beam not to be diverted by hitting molecules on its way towards the build. Normally, the vacuum chamber in the additive manufacturing apparatus encompasses both the particle beam source and the build tank, so that vacuum is maintained in the whole system.

DE102017208651 describes a separate and movable manufacturing module which is designed to be coupled to an additive manufacturing station for the additive manufacturing of a component.

### PROBLEMS WITH THE PRIOR ART

When the build tank is integrated into the vacuum chamber, the vacuum will insulate the build tank, so that it takes a long time to cool the finished build.

There is thus a need for an improved apparatus and method for additive manufacturing.

### SUMMARY

The above described problem is addressed by the claimed apparatus for additive manufacturing. The apparatus preferably comprises a particle beam providing module and a removable build module. The removable build module preferably comprises: a build tank, comprising walls; at least one powder supply tank; and a recoating arrangement, arranged to recoat the build tank with powder from the at least one powder supply tank. The particle beam providing module and the removable build module preferably together form a vacuum chamber when the removable build module is attached to the particle beam providing module in the apparatus, so that the walls of the build tank form a barrier part of said vacuum chamber. A cover of the removable build module preferably forms a part of the particle beam providing module, and is arranged to be automatically removed from the removable build module when the removable build module is removed from the apparatus, for easy access to the build tank.

The above described problem is further addressed by the claimed method for additive manufacturing using an apparatus comprising a particle beam providing module and a removable build module comprising a build tank, comprising walls, at least one powder supply tank, and a recoating arrangement. The method preferably comprises: arranging a cover of the removable build module to form a part of the particle beam providing module, and be automatically removed from the removable build module when the removable build module is removed from the apparatus, for easy access to the build tank; filling the at least one powder supply tank in the removable build module with powder; attaching the removable build module to the particle beam providing module so that they together form a vacuum chamber in the apparatus, where the walls of the build tank form a barrier part of said vacuum chamber; applying vacuum pressure to the removable build module and the particle beam providing module; creating a powder bed in the build tank using the recoating arrangement and powder from the at least one powder supply tank; successively forming a build in the build tank, using selective particle beam powder bed fusion on successive layers of the powder bed, while successively recoating the build tank using the recoating arrangement; removing the removable build module from the particle beam providing module; and removing the build from the build tank.

This enables an improved cooling of the build tank, since it will not be surrounded, and thereby insulated, by vacuum. Further, vacuum is only maintained in the build tank as long as the particle beam providing module and the removable build module are connected, since the walls of the build tank form a barrier part of the vacuum chamber that is formed together with the particle beam providing module. The definition that the walls of the build tank form a barrier part of the vacuum chamber should be understood to mean that the walls of the build tank are a vacuum barrier in the sense that they are air tight, so that air cannot enter the vacuum chamber formed by the build tank and the particle beam providing module.

The above described problem is also addressed by the claimed arrangement for additive manufacturing. The arrangement preferably comprises a plurality of apparatuses for additive manufacturing, each apparatus comprising a particle beam providing module and a removable build module. The arrangement preferably comprises a central module comprising resources that are shared by all the apparatuses in the arrangement.

The above described problem is further addressed by the claimed method for additive manufacturing using an arrangement comprising a plurality of apparatuses for additive manufacturing, each apparatus comprising a particle beam providing module and a removable build module. The method preferably comprises arranging all the apparatuses in the arrangement to share resources comprised in a central module.

This enables more efficient additive manufacturing.

The resources are preferably resources that are used during the additive manufacturing process. The arrangement preferably comprises interfaces to each of the build modules, where the build modules connect to the resources. Each interface may e.g. comprise a vacuum connection for a backing vacuum, a cooling fluid connection, and one or more electrical connections.

In embodiments, the cover covers both the build tank and the at least one powder supply tank, so that the tops of both the build tank and the at least one powder supply tank are open when the removable build module is removed from the apparatus, for easy refill of the at least one powder supply tank.

In embodiments, the walls of the build tank are arranged to be cooled by cooling fluid arranged around said walls.

In embodiments, the apparatus comprises two separate powder supply tanks.

In embodiments, the particle beam providing arrangement comprises a particle beam source.

In embodiments, the particle beam source is an electron beam source.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIGS. 1 and 2 illustrate an embodiment of an apparatus for additive manufacturing, in accordance with one or more embodiments described herein.

FIG. 3 illustrates details of an embodiment of an apparatus for additive manufacturing, in accordance with one or more embodiments described herein.

FIGS. 4 and 5 illustrate an embodiment of an arrangement for additive manufacturing, in accordance with one or more embodiments described herein.

FIG. 6 schematically illustrates the inside of an arrangement for additive manufacturing, in accordance with one or more embodiments described herein.

FIG. 7 schematically illustrates a method for additive manufacturing, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

In additive manufacturing using a particle beam, such as e.g. Electron Beam Powder Bed Fusion (E-PBF), vacuum is required in order for the particle beam not to be diverted by hitting molecules on its way towards the build. If the build tank is integrated into the vacuum chamber, the vacuum will insulate the build tank, so that it takes a long time to cool the finished build. According to the described concept, the apparatus instead comprises a particle beam providing module and a removable build module, which together form a vacuum chamber, so that the walls of the build tank form a barrier part of said vacuum chamber. This concept enables cooling of the build tank while vacuum is maintained in the vacuum chamber.

The use of a removable build module also makes it possible to avoid all handling of metal powder in the area where the additive manufacturing takes place, which is advantageous. The concept further enables the use of removable build modules where the tops of both build tanks and powder supply tanks are open, for easier access to both build tanks (for build removal) and powder supply tanks (for refill).

The present disclosure relates generally to apparatuses and methods for additive manufacturing. Embodiments of the disclosed solution are presented in more detail in connection with the figures.

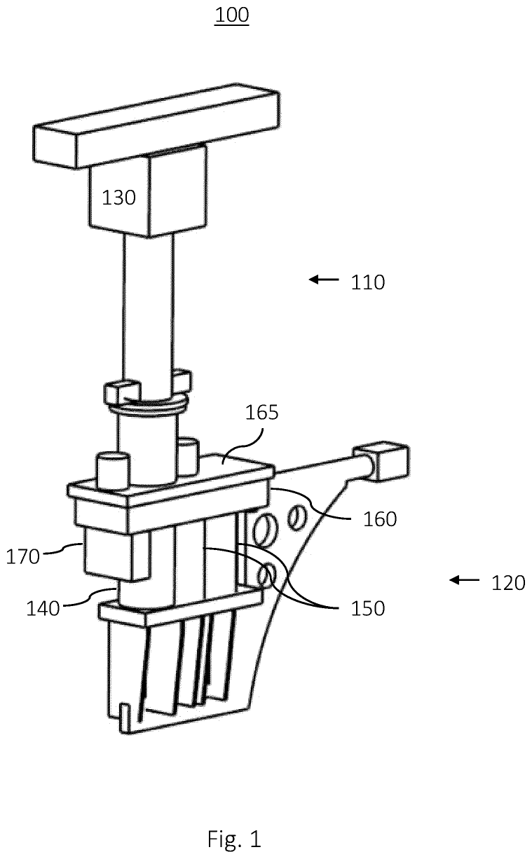

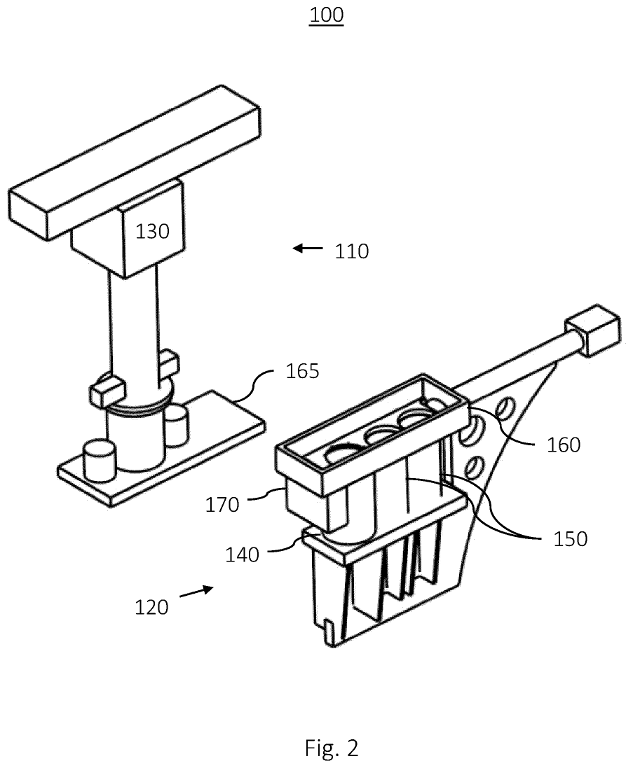

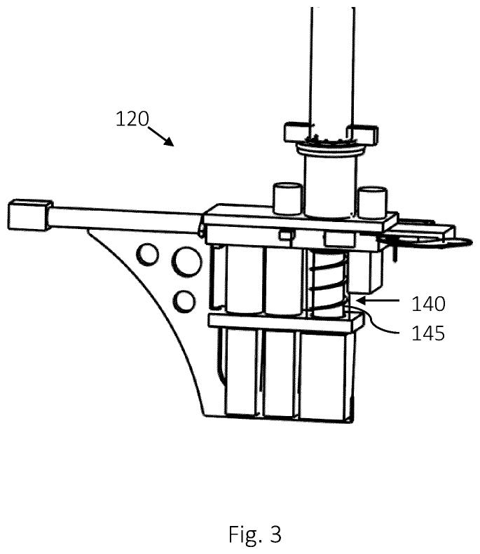

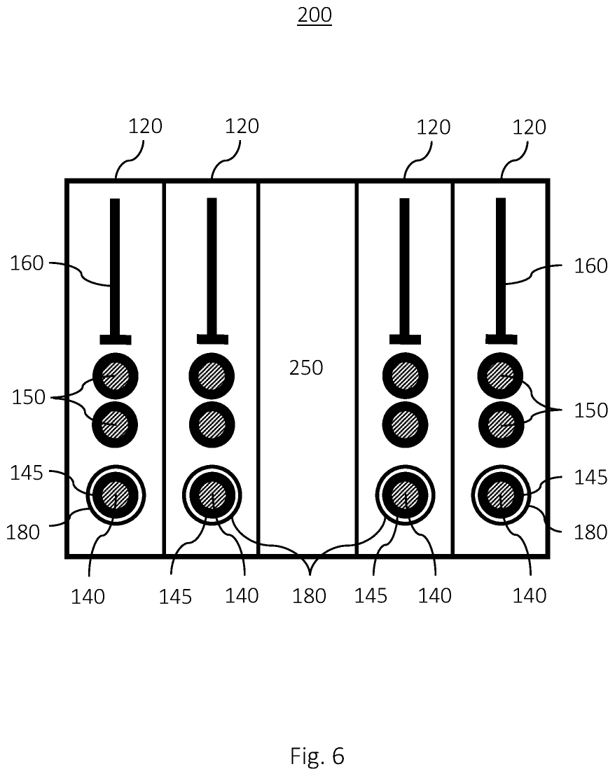

FIGS. 1 and 2 schematically illustrate an embodiment of an apparatus 100 for additive manufacturing. The illustrated apparatus 100 comprises a particle beam providing module 110 comprising a particle beam source 130, and a removable build module 120 comprising a build tank 140, two powder supply tanks 150, and a recoating arrangement 160, which is arranged to recoat the build tank 140 with powder from the powder supply tanks 150. The build tank 140 comprises walls 145 (shown in FIGS. 3 and 6) that may be arranged to be cooled by cooling fluid arranged around the walls 145.

As illustrated in FIG. 2, the removable build module 120 may be removed from the apparatus 100. In the embodiment illustrated in FIGS. 1 and 2, the particle beam providing module 110 comprises a cover 165 for the removable build module 120, Thus, the top of the removable build module 120 is arranged to be open when the removable build module 120 is removed from the apparatus 100, since the cover 165 stays in the apparatus 100 when the removable build module 120 is removed. This allows for easy access to the build tank 140 when the removable build module 120 is removed from the apparatus 100. It is possible for the cover 165 to cover only the build tank 140, but it is preferred that the cover 165 covers both the build tank 140 and the one or more powder supply tanks 150, so that the tops of both the build tank 140 and the one or more powder supply tanks 150 are open when the removable build module 120 is removed from the apparatus 100. This allows for easy refill of the one or more powder supply tanks 150.

The particle beam providing module 110 and the removable build module 120 preferably together form a vacuum chamber when the removable build module 120 is attached to the particle beam providing module 110 in the apparatus 100. There is then no need for the apparatus 100 to be enclosed inside any external vacuum chamber. In this way, the walls 145 of the build tank 140 form a barrier part of the vacuum chamber formed together with the particle beam providing module 110. In order for the build floor of the build tank 140 to be movable, as is typically desirable in additive manufacturing using build tanks, a vacuum seal against a piston or similar that moves the floor would typically be needed at the bottom of the build tank 140.

This concept allows the cooling of the walls 145 of the build tank 140 by cooling fluid arranged around the walls 145 of the build tank 140 while the additive manufacturing process is still ongoing. This makes it possible to remove the build from the build tank 140 shortly after removing the build module 120 from the apparatus 100. Vacuum is only maintained in the build tank 140 as long as the particle beam providing module 110 and the removable build module 120 are connected, since the walls 145 of the build tank 140 form a barrier part of the vacuum chamber that is formed together with the particle beam providing module 110.

When a build is finalized, and the build module 120 is removed from the apparatus 100, a new build module 120 is preferably immediately inserted, and a new build started. This enables a more efficient use of the apparatus 100. After being removed from the apparatus 100, the build module 120 is preferably taken to a turnaround station. At the turnaround station, the build is removed from the build tank 140, and the build module 120 is thereby cleared of the build. The build module 120 is then prepared for the next build, e.g. by the one or more powder tanks 150 being refilled.

Since the walls 145 of the build tank 140 may be cooled by the cooling fluid while the additive manufacturing process is still ongoing, it may be possible to remove the build from the build tank 140 without any additional cooling, either directly, or after letting the build module 120 sit at the turnaround station for some time after being removed from the apparatus 100. However, in embodiments, additional cooling of the walls 145 of the build tank 140 takes place at the turnaround station.

The cooling fluid that may be used for cooling the walls 145 of the build tank 140 may e.g. be a cooling liquid, arranged to be circulated and cooled by a cooling system 170. Such a cooling system 170 may e.g. comprise a pump for circulating the cooling liquid, and a heat exchanger for cooling the cooling liquid. The cooling liquid may e.g. be water.

FIG. 3 illustrates details of an embodiment of an apparatus for additive manufacturing, where the walls 145 of the build tank 140 are shown. In the embodiment of FIG. 3, there is a space surrounding the walls 145. This space would typically be enclosed by container walls 180 (not shown in FIG. 3, but schematically illustrated in FIG. 6). The cooling fluid is preferably arranged in the space between the walls 145 of the build tank 140 and the container walls 180. In order to improve the circulation of the cooling fluid, spiral ridges may be arranged in this space, as shown in FIG. 3.

In order for the cooling effect of the cooling fluid to benefit the cooling of the walls 145 of the build tank 140 as much as possible, it is an advantage if the container walls 180 are made of a material that has a lower thermal conductivity than the material of the walls 145 of the build tank 140. In an embodiment, the walls 145 of the build tank 140 are made of aluminum, and the container walls 180 are made of stainless steel.

The particle beam source 130 may be any type of particle beam source, such as an electron beam source, e.g. in the form of an electron gun with the required electron optics and beam controlling equipment.

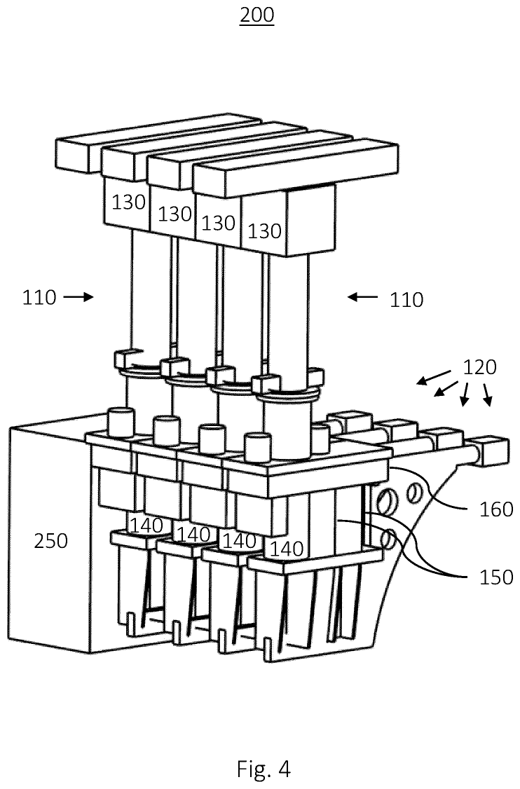

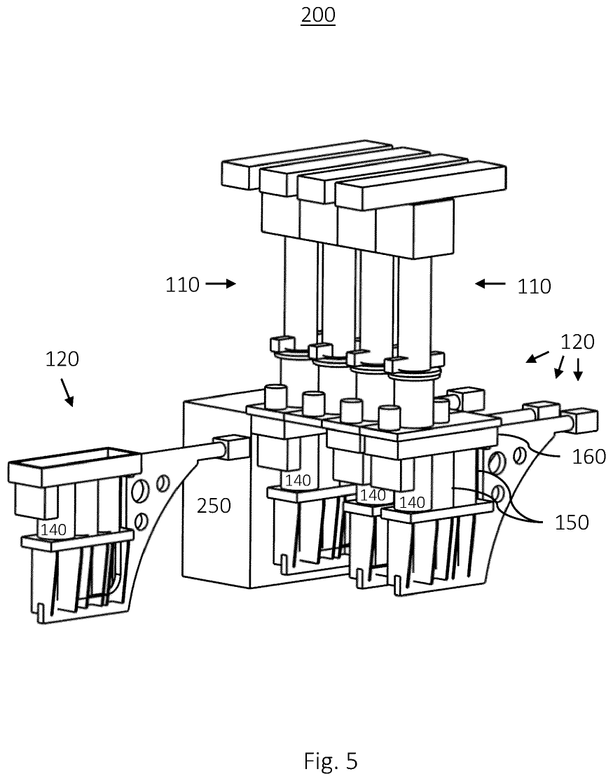

In order to make additive manufacturing more efficient, it is possible to group a number of apparatuses 100 into an arrangement 200 for additive manufacturing. Such an arrangement 200 may e.g. be called a melt station. FIGS. 4 and 5 schematically illustrate an embodiment of such an arrangement 200 for additive manufacturing, where four apparatuses 100 have been grouped together. Apart from being efficient for space and for handling of the apparatuses 100, this also allows for the sharing of resources by all the apparatuses 100 in the arrangement 200 during the additive manufacturing process. The arrangement 200 illustrated in FIGS. 4 and 5 comprises a support system in the form of a central module 250 comprising resources that are shared by the apparatuses 100 in the arrangement 200. FIGS. 4 and 5 show the central module 250 being arranged at the side of the apparatuses 100, but the central module 250 may be arranged anywhere in the arrangement 200, such as e.g. between two apparatuses 100.

FIG. 6 schematically illustrates the inside of another embodiment of an arrangement 200 for additive manufacturing, seen from the top of the build modules 120, with the particle beam providing modules 110 removed in this illustration. In this embodiment, four apparatuses 100 have been grouped together, with a central module 250 arranged in the middle, between two apparatuses 100. The central module 250 may have the same width as the apparatuses 100, or a different width. It may be fixedly mounted in a certain position in the arrangement 200, or be movable between different positions. The central module 250 may comprise resources such as a control computer, a backing vacuum pump, a central cooling system, power supplies, and/or various electronics. The resources are preferably resources that are used during the additive manufacturing process. If the central cooling system comprises means for circulating the cooling fluid, such as e.g. a pump, and means for cooling the fooling fluid, such as e.g. a heat exchanger, the apparatuses 100 may not need to comprise any separate cooling systems 170. The arrangement 200 preferably comprises interfaces to each of the build modules 120, where the build modules 120 connect to the resources. Each interface may e.g. comprise a vacuum connection for the backing vacuum, a cooling fluid connection, and one or more electrical connections.

FIG. 6 illustrates the walls 145 of the build tanks 140, and how the recoating arrangement 160 is arranged to recoat the build tank 140 with powder from the two powder supply tanks 150. There may be any number of powder supply tanks 150 in each apparatus 100. The build tank 140 and the one or more powder supply tanks 150 may have any shape, e.g. cylindrical, as illustrated in FIG. 6.

An arrangement 200 for additive manufacturing comprising four build modules 120 and a central module 250 may e.g. be about 2,5 meters wide. Each build module 120 would in this case e.g. be about 50 cm wide.

When an arrangement 200 for additive manufacturing is used, one single turnaround station is preferably shared between the apparatuses 100 in the arrangement 200. One single turnaround station may also be shared between a number of different arrangements 200 for additive manufacturing. Each build module 120 is preferably taken to the turnaround station immediately after being removed from an arrangement 200. At the turnaround station, the build is removed from the build tank 140, and the build module 120 is thereby cleared of the build. The build module 120 is then prepared for the next build, e.g. by the powder tanks 150 being refilled.

An additive manufacturing site may comprise a large number of arrangements 200 for additive manufacturing. Each arrangement 200 preferably has a service side and an operator side. The operator side is the side where the build modules 120 are removed from the arrangement 200. The arrangements 200 are preferably positioned with the service sides towards each other to form a service shaft, and with the operator sides facing one or more turnaround stations. This makes the operating of the arrangements 200, including the docking in and out of the build modules 120, much more efficient.

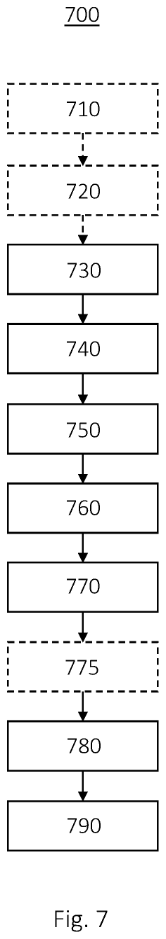

FIG. 7 schematically illustrates a method 700 for additive manufacturing using an apparatus 100 comprising a particle beam providing module 110 and a removable build module 120 comprising a build tank 140, comprising walls 145, at least one powder supply tank 150, and a recoating arrangement 160. The method 700 may comprise:
Step 710: arranging a cover 165 of the removable build module 120 to form a part of the particle beam providing module 110, and be automatically removed from the removable build module 120 when the removable build module 120 is removed from the apparatus 100, for easy access to the build tank 140.
Step 730: filling the at least one powder supply tank 150 in the removable build module 120 with powder.
Step 740: attaching the removable build module 120 to the particle beam providing module 110 so that they together form a vacuum chamber in the apparatus 100, where the walls 145 of the build tank 140 form a barrier part of said vacuum chamber.
Step 750: applying vacuum pressure to the removable build module 120 and the particle beam providing module 110.
Step 760: creating a powder bed in the build tank 140 using the recoating arrangement 160 and powder from the at least one powder supply tank 150.
Step 770: successively forming a build in the build tank 140, using selective particle beam powder bed fusion on successive layers of the powder bed, while successively recoating the build tank 140 using the recoating arrangement 160.
Step 780: removing the removable build module 120 from the particle beam providing module 110.
Step 790: removing the build from the build tank 140.

This enables an improved cooling of the build tank, since it will not be surrounded, and thereby insulated, by vacuum. Further, vacuum is only maintained in the build tank as long as the particle beam providing module and the removable build module are connected, since the walls of the build tank form a barrier part of the vacuum chamber that is formed together with the particle beam providing module.

The method 700 may further comprise one or more of:
Step 720: arranging the cover 165 to cover both the build tank 140 and the at least one powder supply tank 150, so that the tops of both the build tank 140 and the at least one powder supply tank 150 are open when the removable build module 120 is removed from the apparatus 100, for easy refill of the at least one powder supply tank 150.
Step 775: cooling the walls 145 of the build tank 140 during the process of forming the build, using cooling fluid arranged around said walls 145. This step preferably takes place simultaneously with step 770.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

1. An apparatus for additive manufacturing, the apparatus comprising a particle beam providing module and a removable build module, wherein the removable build module comprises:
a build tank comprising walls;
at least one powder supply tank; and
a recoating arrangement, arranged to recoat the build tank with powder from the at least one powder supply tank,
wherein the particle beam providing module and the removable build module together form a vacuum chamber when the removable build module is attached to the particle beam providing module in the apparatus, so that the walls of the build tank form a barrier part of said vacuum chamber.

2. The apparatus according to claim 23, wherein the cover covers both the build tank and the at least one powder supply tank so that the top of both the build tank and the at least one powder supply tank are open when the removable build module is removed from the apparatus for easy refill of the at least one powder supply tank.

3. The apparatus according to claim 1, wherein the walls of the build tank are arranged to be cooled by cooling fluid arranged around said walls.

4. The apparatus according to claim 1, wherein the at least one powder supply tank comprises two separate powder supply tanks.

5. The apparatus according to claim 1, wherein the particle beam providing module comprises a particle beam source.

6. The apparatus according to claim 5, wherein the particle beam source is an electron beam source.

7. An arrangement for additive manufacturing, comprising a plurality of apparatuses, wherein each apparatus is the apparatus according to claim 1.

8. An arrangement for additive manufacturing, comprising four apparatuses, wherein each apparatus is the apparatus according to claim 1.

9. The arrangement according to claim 7, further comprising a central module comprising resources that are shared by all the apparatuses in the arrangement.

10. An arrangement for additive manufacturing, comprising:
a plurality of apparatuses for additive manufacturing, each apparatus comprising:
a particle beam providing module, and
a removable build module; and
a central module comprising resources that are shared by all the apparatuses in the arrangement.

11. The arrangement according to claim 10, wherein the particle beam providing module and the removable build module together form a vacuum chamber when the removable build module is attached to the particle beam providing module.

12. The arrangement according to claim 10, wherein a cover of the removable build module forms a part of the particle beam providing module and is arranged to be automatically removed from the removable build module when the removable build module is removed from the apparatus.

13. The arrangement according to claim 10, wherein the particle beam providing module comprises a particle beam source.

14. The arrangement according to claim 13, wherein the particle beam source is an electron beam source.

15. The arrangement according to claim 10, wherein the removable build module comprises:
a build tank comprising walls;
at least one powder supply tank; and
a recoating arrangement arranged to recoat the build tank with powder from the at least one powder supply tank,
wherein the particle beam providing module and the removable build module together form a vacuum chamber when the removable build module is arranged in the apparatus, so that the walls of the build tank form a barrier part of said vacuum chamber.

16. The arrangement according to claim 15, wherein the walls of the build tank are arranged to be cooled by cooling fluid arranged around said walls.

17. The arrangement according to claim 15, wherein the at least one powder supply tank comprises two separate powder supply tanks.

18. A method for additive manufacturing using an apparatus comprising a particle beam providing module and a removable build module the removable build module comprising a build tank comprising walls at least one powder supply tank and a recoating arrangement, the method comprising:
filling the at least one powder supply tank in the removable build module with powder;
attaching the removable build module to the particle beam providing module so that they together form a vacuum chamber in the apparatus, where the walls of the build tank form a barrier part of said vacuum chamber;
applying vacuum pressure to the removable build module and the particle beam providing module;
creating a powder bed in the build tank using the recoating arrangement and powder from the at least one powder supply tank;
successively forming a build in the build tank using selective particle beam powder bed fusion on successive layers of the powder bed, while successively recoating the build tank using the recoating arrangement;
removing the removable build module from the particle beam providing module; and
removing the build from the build tank.

19. The method according to claim 18, further comprising arranging the cover to cover both the build tank and the at least one powder supply tank so that the tops of both the build tank and the at least one powder supply tank are open when the removable build module is removed from the apparatus for easy refill of the at least one powder supply tank.

20. The method according to claim 18, further comprising cooling walls of the build tank during the process of forming the build, using cooling fluid arranged around said walls

21. A method for additive manufacturing, using an arrangement comprising a plurality of apparatuses for additive manufacturing, each apparatus comprising a particle beam providing module and a removable build module, the method comprising arranging all the apparatuses in the arrangement to share resources comprised in a central module.

22. The method for additive manufacturing according to claim 21, further comprising arranging the particle beam providing module and the removable build module to together form a vacuum chamber when the removable build module is attached to the particle beam providing module.

23. The apparatus according to claim 1, wherein a cover of the removable build module forms a part of the particle beam providing module and is arranged to be automatically removed from the removable build module when the removable build module is removed from the apparatus for easy access to the build tank.

24. The method according to claim 18, further comprising arranging a cover of the removable build module to form a part of the particle beam providing module and to be automatically removed from the removable build module when the removable build module is removed from the apparatus for easy access to the build tank.
